(19) United States
(12) Patent Application Publication
(10) Pub. No.: US 2009/0220739 A1
(43) Pub. Date: Sep. 3, 2009

(54) SELECTIVELY PERMEABLE FILMS

(76) Inventor: Vivek A. Chougule, Williamsburg, VA (US)

Correspondence Address: MCANDREWS HELD & MALLOY, LTD, 500 WEST MADISON STREET, SUITE 3400, CHICAGO, IL, 60661, US

(21) Appl. No.: 12/095,447

(22) PCT Filed: Dec. 8, 2006
(86) PCT No.: PCT/US06/47079

§ 371 Date: Oct. 8, 2008

Related U.S. Application Data
(60) Provisional application No. 60/749,342, filed on Dec. 9, 2005.

(51) Int. Cl. B32B 27/00; C08J 9/00; C08L 47/00; C08L 75/04; B32B 3/26; B32B 3/10; B32B 27/30; B32B 27/12; B32B 27/32; B65D 81/24

(52) U.S. Cl. 428/138; 521/134; 521/140; 521/137; 428/304.4; 428/316.6; 442/394; 442/286

(57) ABSTRACT

This invention relates to films having selective permeability and/or permeation rates for different gases, liquids, particulate matter, and combinations thereof. The films may be employed as packaging films or separation membranes. The films may be comprised of at least one layer including one or more high permeability polymers blended with one or more low permeability polymers. Blending of different amounts and combinations of low and high permeability polymers may provide a method by which individual permeation and permeation rates can be increased or decreased, and made selective for one or more gasses, liquids, particulate matter or combinations thereof. Methods for making such films are also disclosed.

### CROSS-REFERENCE TO RELATED APPLICATIONS/INCORPORATION BY REFERENCE

This patent application makes reference to, claims priority to and claims benefit from U.S. Provisional Patent Application Ser. No. 60/749,342, filed on Dec. 9, 2005.

### BACKGROUND OF THE INVENTION

The presently described technology relates generally to the art of packaging films, and more particularly to gas permeation packaging films having selective permeability rates for different gases, liquids, particulate matter, microbial agents, and/or combinations or derivatives thereof. The films of the presently described technology are suitable for a variety of uses including packaging films.

Film technology has a wide variety of uses. Depending upon the application, the utility of a particular film depends upon any number of variable parameters including, but not limited to, gas permeability rates and selectivity, tensile strength, clarity, odor, light transmission, and other physical traits. Permeability rates for different gasses are important for films having utility as food packaging that is intended to extend the shelf life of a packaged food. For example, films have been utilized for the packaging of “oxygen-sensitive products”, i.e., products that exhibit lower shelf-life in the presence of either too much or too little oxygen being allowed into or out of the package. For such films, the O₂-transmission rate, and at times the CO₂-transmission rate, are of primary importance. These films often purport to provide a gas barrier layer that can minimize oxygen ingress and retain a protective atmosphere inside of the packaging.

Very high respiration rate commodities such as broccoli, asparagus and mushrooms have always presented a challenge to packagers. Porous or micro-perforated polypropylene laminated to polyethylene based sealant webs have found utility in packaging requiring high gas transmission. Although these films by themselves provide a high rate of gas transmission, the perforated structure allows gasses to flow at the same rate, and does not provide a barrier to particulate matter (e.g., dust or dirt) and/or microbes such as viruses, bacteria, fungi, protozoa or other parasites. Additionally, preparation of these films requires a multi-staged production process that includes, for example, the steps of formation of the polypropylene film, perforation, and lamination.

Another approach to increasing gas permeability is the use of a patch system to increase overall oxygen permeability of the package. A patch system typically involves perforating a laminated film, and then covering the perforations with gas permeable stickers or patches. Such patch systems, however, result in additional cost, reduced packaging speeds, and increased unacceptable packages due to inconsistent quality.

Thus, there is a need for a film with higher selectivity for permeability that may be produced in a single converting step, that offers a barrier to infectious microbes and other particulate matter, and that offers a high rate of gas transmission while retaining selective permeation rates for different gasses, liquids and the like.

### BRIEF SUMMARY OF THE INVENTION

One aspect of the present technology provides for films having selective permeation rates for different gases, liquids, particulate matter, and combinations thereof. Another aspect of the present technology provides for flexible, permeable films having selective permeation rates for different gases, liquids, particulate matter, and combinations thereof. A still further aspect of the present technology is to produce the above-described films in a single, nonlamination converting step, thereby avoiding the increased cost of lamination or other processing to achieve selective permeation.

Additionally another aspect of the present technology is to provide films with high oxygen permeability that can find applications in retail packaging of high respiration produce and/or larger size produce packaging (resulting in higher produce weight to package surface area ratio). Moreover, a further aspect of the present technology is to provide films that have different permeation rates for oxygen and carbon dioxide that can result in a modified atmosphere inside of the resultant package, providing better shelf life for produce or other perishable items. A still further aspect of the present technology is to provide a barrier to particulate matter (e.g., dust or dirt) and/or microbes such as viruses, bacteria, fungi, protozoa, or other parasites.

One or more of the preceding aspects, or one or more other aspects which will become plain upon consideration of the present specification, are satisfied by one or more embodiments of the present technology described herein.

At least one embodiment of the present technology, which satisfies one or more of the above aspects, is a film comprising a selectively permeable polymer or polymer blend. The selectively permeable polymer or polymer blend may include a high permeability polymer component and may also include a low permeability polymer component. By varying the content of each of these components, the permeability of a particular gas or other permeation target (e.g., liquid or solid) may be selectively increased or decreased. At least one of the embodiments of the present technology is a multilayer film comprising a selectively permeable polymer or polymer blend forming a core layer, and one or more outer skin layers disposed on one or both sides of the core layer. In at least one embodiment of the present technology, the multilayer film is made in a single, nonlamination converting step.

### BRIEF DESCRIPTION OF SEVERAL VIEWS OF THE FIGURES

FIG. 1 represents polymer blends and polymer blend morphologies for blends with varying amounts of low and high permeability polymers blended to produce desired permeation rates for different gases, liquids, particulate matter, and combinations thereof.

FIG. 2 is an illustration of a representation of a film according to the present technology having a selectively permeable polymer or polymer blend.

FIG. 3 presents film formulations with varying concentrations of low and high permeability polymers blended together.

FIG. 4 presents O₂ and CO₂ permeation rates for select films presented in FIG. 3.

FIG. 5 presents optical, surface, and tensile properties for select films presented in FIG. 3.

FIG. 6 is an illustration of a multilayer film according to the present technology having a core layer comprising a selectively permeable polymer or polymer blend and a skin layer disposed on one side of the core.

FIG. 7 is an illustration of a multilayer film according to the present technology having a core layer comprising a selectively permeable polymer or polymer blend disposed between two skin layers.

FIG. 8 represents film formulations of multilayer films which illustrate limitations in achieving higher oxygen permeability rates.

FIG. 9 represents formulations of exemplar multilayer films according to the present technology.

FIG. 10 represents O₂ and CO₂ permeation rates for films presented in FIG. 9.

FIG. 11 represents formulations of exemplar multilayer films according to the present technology.

FIG. 12 represents formulations of exemplar multilayer films according to the present technology.

FIG. 13 describes optical and physical properties for representative films presented in FIGS. 11 and 12.

FIG. 14 represents formulations of exemplar multilayer films according to the present technology.

FIG. 15 describes O₂ permeation rates for those films presented in FIG. 14.

FIG. 16 describes optical and physical properties for the films presented in FIG. 14.

FIG. 17 describes O₂ permeation rates for commercially available fresh produce packaging films.

FIG. 18 is a graphical illustration of the Maxwell model droplet morphology showing the effect of blend composition on oxygen permeability.

### DETAILED DESCRIPTION OF THE INVENTION

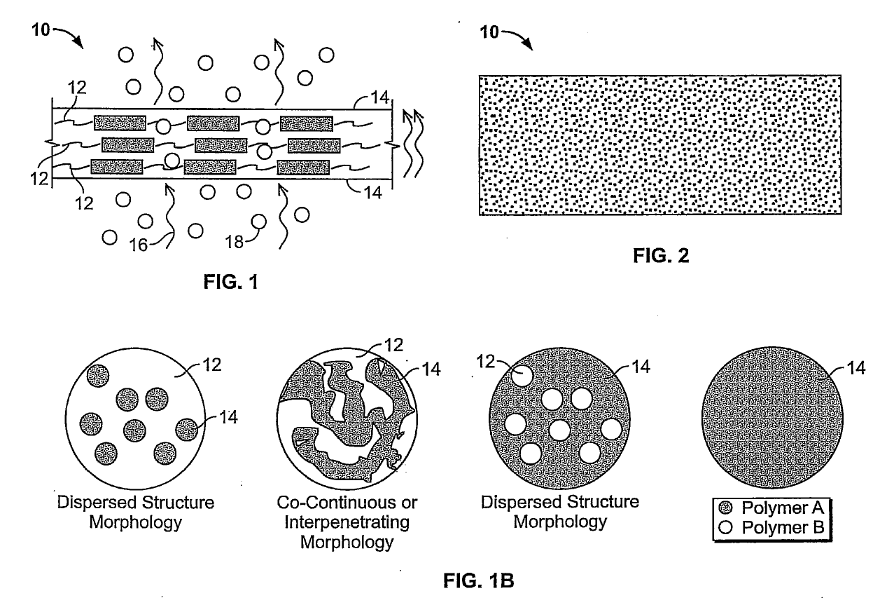

FIG. 1A is an illustration of at least one film according to the present technology, referenced generally at 10, and showing one perspective view of the selectively permeable polymer blend contained therein comprising one or more high permeability polymers 14, blended with one or more low permeability polymers 12. Blending of different amounts and combinations of low and high permeable polymers 12, 14 provides a method by which individual gas permeation (indicated at 16) and permeation rates can be increased or decreased, and made selective for one or more gasses 18. The polymers can be dry blended and then fed into an extruder. The blending can be done inline by using gravimetric feeding systems or, alternatively, can be dry blended offline.

FIG. 1B represents polymer blend morphologies for blends of the present technology with varying amounts of immiscible low and high permeability polymers 12, 14 which are blended to produce desired permeation rates for different gases, liquids, particulate matter, and combinations thereof.

FIG. 1B shows a first morphology (1) in which the high permeability polymer 14 is dispersed throughout the low permeability polymer 12. Such a morphology may not provide the polymer channels necessary for selective gas permeation because the low permeability polymer 12 forms the bulk of the film, as well as the film major phase morphology.

FIG. 1B shows a second morphology (2) in which the high permeability polymer 14 is percolating, co-continuous or interpenetrating with the low permeability polymer 12. Such a morphology would provide the permeable polymer channels necessary for selective gas permeation. Although not wishing to be bound by any particular theory, it is believed that such a percolating, co-continuous or interpenetrating morphology begins to form at a high permeability polymer 14 content of about 15% by weight of the film formulations of the present technology. The content of immiscible polymer blend components that are required to obtain a percolating, co-continuous or interpenetrating blend is in general affected by the viscosity ratio, the interfacial energy between the polymer components, and the process used. Research literature suggests that at least about 15% of the minor component of the polymer in the blend is required to form a percolating, co-continuous or interpenetrating blend when the polymers are processed using conventional extruder blending. FIG. 1B shows a third morphology (3) in which the low permeability polymer 12 is dispersed throughout the high permeability polymer 14. Such a morphology would provide the permeable polymer channels desired for selective gas (or liquid) permeation because the high permeability polymer 14 forms the bulk of the film 10, as well as the film major phase morphology.

FIG. 1B shows a fourth morphology (4) comprising 100% high permeability polymer 14. Since only high permeability polymer is present with such a morphology, the polymer blend is a monoblend. Such a morphology would provide the maximum gas permeation for a given high permeability polymer 14.

For the films of the present technology, the high permeability polymer(s) 14 may generally range from about 15 wt % to about 100 wt % of the film 10 made from the selectively permeable composition or composition blend. The low permeability polymers 12 may generally range up to about 85 wt % of the film 10 made from the selectively permeable composition blend. Polymers typically characterized as having a high permeability for O₂ provide oxygen permeability higher than 600 O₂ cc-mil/100 in²×day×atmosphere (normalized to 1 mil thickness) at 23° C. as measured per ASTM D3985. Polymers typically characterized as having a low permeability for O₂ provide oxygen permeability between 50 to 600 O₂ cc-mil/100 in²×day×atmosphere (normalized to 1 mil thickness) at 23° C. as measured per ASTM D3985.

It should also be understood by those skilled in the art that the films of the present technology also exhibit improved barrier properties to a variety of particulates ranging from dust and dirt to microbes.

The high permeability polymers 14 may include but are not limited to ethylene-vinyl acetate, ethylene-butyl acrylate, ethylene-methyl acrylate, glycidyl methacrylate, copolyesters, urethane, polyethylene, propylene, propylene-ethylene, polyolefin, polyolefin plastomer, a low-density polyethylene, a very-low-density polyethlyene, an ultra-low-density polyethylene, a linear-low-density polyethylene, styrene butadiene, polystyrene, methylpentene co-polymer, derivatives thereof, and combinations thereof. The high permeability polymer 14 may be a symmetric co-polymer, an ionomeric polymer, a random co-polymer, a graft co-polymer, a block co-polymer, an impact co-polymer, and combinations thereof. Persons skilled in the art will understand the processing of these polymers and polymer blends in order to achieve high permeability characteristics. The high permeability polymers or polymer blends may also be referred to as the high permeability polymer component.

The low permeability polymers 12 may include, but are not limited to polyethylene, low-density polyethylene, linear-low-density polyethylene, propylene homo-polymer, propylene-ethylene random co-polymer, propylene-ethylene impact co-polymer, polyolefin plastomers, ethylene vinyl acetate copolymer, styrene butadiene co-polymer, styrene butadiene rubber, polystyrene, derivatives thereof, and combinations thereof. The low permeability polymer 12 may be a symmetric co-polymer, a random co-polymer, a graft co-polymer, a block co-polymer, an impact co-polymer, and combinations thereof. Persons skilled in the art will understand the processing of these polymers and polymer blends in order to achieve low permeability characteristics. The low permeability polymers or polymer blends may also be referred to as the low permeability polymer component.

From the above recitations of the types of polymers that are high permeability polymers and those that are low permeability polymers, it is apparent that there is some overlap between the two types of polymers. For example, low density polyethylene is listed among the high permeability polymers as well as the low permeability polymers. The same types of polymers may have different permeability characteristics depending upon, for example, the molecular weight distribution, the crystallinity, the density and the melt index of the polymer. Thus, these polymers may have permeability properties such that one would consider them to be high permeability polymers, but may also have permeability properties such that one would consider them to be low permeability polymers. Determining whether a polymer that can be characterized in both the low and the high permeable polymer groupings is, in a particular application, the low permeable polymer component or the high permeable polymer component will depend upon the target permeation rate that is desired to be achieved for the particular film. Determining how to select the polymers and how to adjust the amounts of the polymers selected in order to achieve a target permeation rate are described in further detail below.

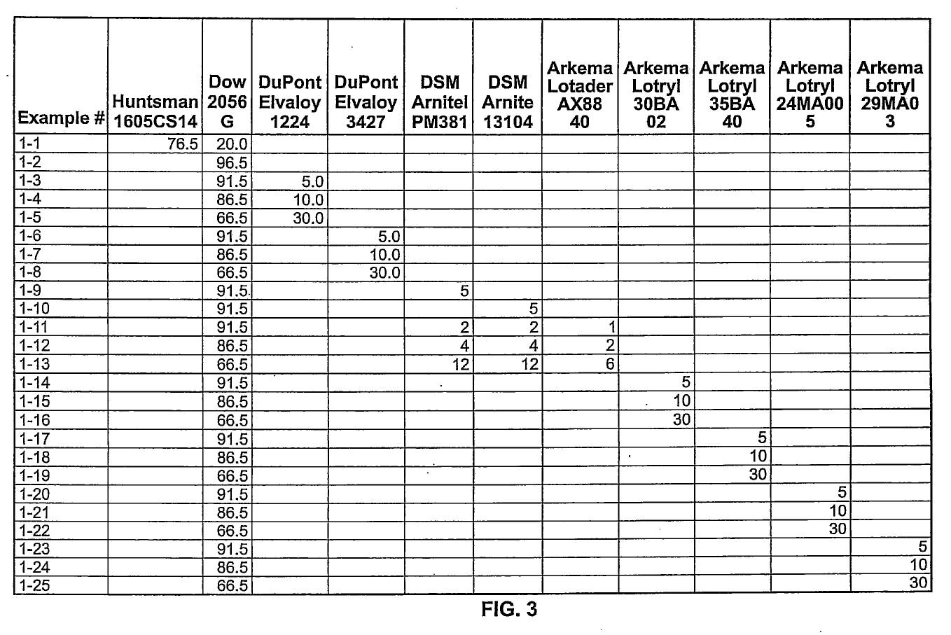

FIG. 2 illustrates a representation of a film according to the present technology, referenced generally at 10 and comprising at least one high permeability polymer or polymer blend and having at least one selective permeation rate for one or more gases. The polymers or polymer blends of this and other aspects of the present technology include, but are not limited to homopolymers, copolymers, or combinations thereof. Polymers or polymer blends can be without limitation ionomeric, non-ionomeric, or combinations thereof. The polymers or polymer blends can also include, but are not limited to thermoplastics, thermosets, elastomers, plastomers, rubber, and combinations thereof.

The film 10 is a monolithic film. Monolithic film or material denotes a solid material; that is, it has no physical holes or perforations. Persons skilled in the art will understand and appreciate that such films provide the additional benefits of being a barrier against liquid, solid, microbial agents (such as a virus, a bacteria, a fungus, a protozoa), and combinations thereof due to the lack of physical holes or perforations. In doing so, materials packaged with or in such films of the present technology are believed to incur less contamination, which in turn, leads to decreased waste and production costs. Additional benefits of utilizing a monolithic film in accordance with the present technology include increased efficiency and cost savings because a perforation step can be eliminated, and better print aesthetics for the film.

The film 10 has a total thickness in the range of about 0.5 to about 5 mil, alternatively in the range of about 1 to about 3 mil, preferably about 2 mil.

FIG. 3 sets forth film formulations, not necessarily within the scope of the present technology, for the purpose of demonstrating that changes in polymer content can effect changes in gas permeability. These films include without limitation polymers and polymer blends comprising from about 20 weight percent to about 100 weight percent of a polyethylene polymer (for example, Dow 2056G sold by the Dow Chemical Company), either alone or blended in different amounts and combinations with other polymers including without limitation an ethylene vinyl acetate copolymer (for example, Huntsman 1605CS14 sold by Huntsman Corporation of Houston, Tex.), an ethylene and methyl acrylate copolymer (for example, DuPont 1224 sold by E.I. du Pont de Nemours and Company), an ethylene and butyl acrylate copolymer (for example, DuPont 3427 sold by E.I. du Pont de Nemours and Company), copolyester (for example, Arnitel PM381 sold by DSM Engineering Plastics), copolyester (for example, Arnitel 3104 sold by DSM Engineering Plastics), glycidyl methacrylate (for example, Lotader AX8840 sold by Arkema of Puteaux, France), ethylene-butyl acrylate (for example, Lotryl 30BA02 or Lotryl 35BA40 sold by Arkema of Puteaux, France), and ethylene-methyl acrylate (for example, Lotryl 24MA005 or Lotryl 29MA03 sold by Arkema of Puteaux, France). The films presented in FIG. 3 may also comprise without limitation about 2 weight percent antioxidant (masterbatch) (for example, Ampacet 100401 sold by Ampacet of Tarrytown, N.Y.) and 1.5 weight percent slip (masterbatch) (for example, Ampacet 10090 sold by Ampacet of Tarrytown, N.Y.). For example, film Example 1-2 includes 96.5 wt % of Dow 2056G, 2 weight percent antioxidant (masterbatch) and 1.5 weight percent slip (masterbatch).

The low permeability polymers of the films of FIG. 3 are Dow 2056G and Huntsman 1605CS14. The remaining polymers identified in FIG. 3 are high permeability polymers.

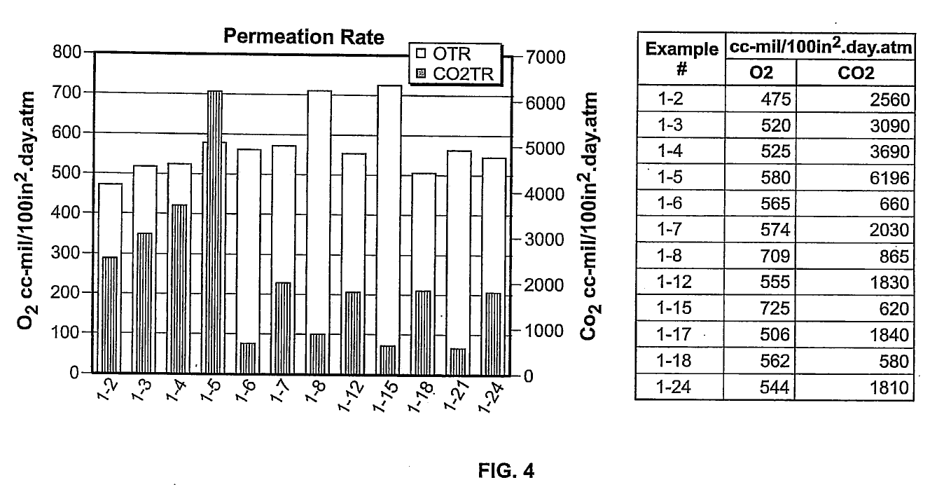

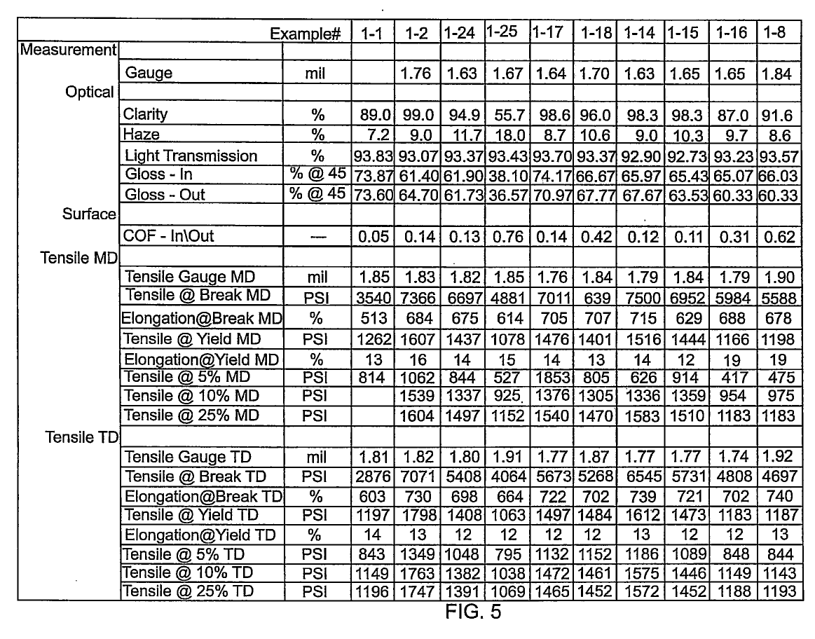

FIG. 4 presents O₂ and CO₂ permeation rates for a representative group of the films presented in FIG. 3, and FIG. 5 provides optical, surface, and tensile properties for some of the films presented in FIG. 3. The O₂ transmission rates were measured using MOCON equipment—Model OXTRAN® 2/20—and CO₂ transmission rates were measured by using MOCON equipment—PERMATRAN-C® Model 4/41 (each available from Modern Controls, Inc. of Minneapolis, Minn.).

The permeation rates were calculated from the transmission rate and the film sample thickness. O₂ permeation rate was determined by using a 100 cm² film sample and CO₂ permeation rate was determined using a 5 cm² film sample. Both O₂ and CO₂ permeation rates were determined at a temperature of 23.0° C., a permeant gas concentration of 100 percent, and a permeant relative humidity of about 50 percent.

FIG. 4 describes that with variations in the concentration of the low permeability polymer and high permeability polymer, the permeation rates for the resulting film may be altered. Specifically, examples 1-2, 1-3, 1-4, 1-5 demonstrate that increasing the concentration of a high permeability polymer in the blend yields increases in gas permeation rates for both CO₂ and O₂. Examples 1-12, 1-15, 1-18, 1-21, and 1-24 demonstrate that different high permeability polymers will result in different permeation rates for both CO₂ and O₂ even at the same high permeability polymer concentration—10% for each of these examples. Oxygen permeation rates for the individual sample films tested ranged from about 475 O₂ cc-mil/100 in²×day×atmosphere to about 725 cc-mil/100 in²×day'atmosphere. Carbon dioxide permeation rates for individual sample films tested ranged from about 580 CO₂ cc-mil/100 in²×day×atmosphere to about 6200 cc-mil/100 in²×day×atmosphere. The CO₂/O₂ permeation rate ratio for individual films tested ranged from about 0.85 to about 11, demonstrating that different permeation rates for oxygen and carbon dioxide can be achieved with the films of the present technology.

A range of CO₂/O₂ permeability ratios among polymeric films can provide a range of CO₂/O₂ concentrations inside packages. Because fruits and vegetables vary in their tolerance to elevated CO₂ levels, this range of gas proportions is useful for tailoring film packaging to the particular product being packaged. For example, a high CO₂ level (approximately 15-20% CO₂, e.g.) in strawberry and blueberry packages is desirable because it tends to reduce mold growth and improve firmness. Additionally, due to the improved barrier properties of the present technology, contamination of such produce to dust, dirt, or microbes is reduced or prevented as well.

Packaging films that have holes or pores admit O₂ and CO₂ at similar rates and therefore the ratios of gases that can result inside such packages are not controlled. For example, it is difficult, if not impossible, to achieve low O₂ levels (approximately 1-5% e.g.) and high CO₂ levels (approximately 15-20% e.g.) with such films because the holes or pores do not allow for any type of control over the rates of O₂ and CO₂ permeation.

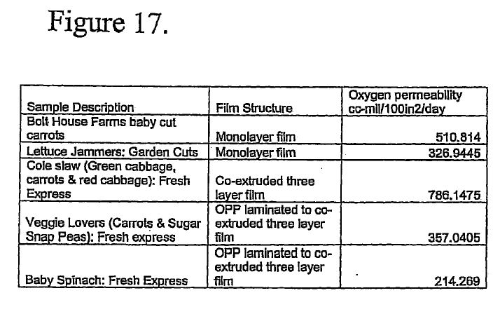

Examples of commercial fresh produce packaging using monolithic films exhibiting limited and low oxygen permeation ranges (See, e.g., FIG. 17). Samples used for these measurements were obtained from commercial retailers. These structures do not provide a mechanism or method to control selective permeability of oxygen and carbon dioxide.

The first three examples of FIG. 17 are non-laminated monolayer or co-extruded films. The oxygen permeability of these three commercial samples is less than about 800 O₂ cc-mil/100 in²×day×atmosphere. The oxygen permeability was measured as discussed above in connection with FIG. 4.

High respiration produce and/or larger size produce packaging (resulting in higher produce weight to package surface area ratio) require increased oxygen permeability. The films of the first three examples of FIG. 17 do not provide the increased oxygen permeability desired for such high respiration applications—typically in excess of 800 O₂ cc-mil/100 in²×day×atmosphere. One solution to the limited oxygen permeability of films such as the first three examples of FIG. 17 is to perforate the film for retail packaging. This solution, while increasing the oxygen permeability, creates physical holes or perforations through which a liquid, solid, or microbial agent may readily pass with minimal control.

Additionally, the film structure as identified in the first three examples of FIG. 17 lack stiffness, crispy feel and gloss, which are considered synonymous with fresh produce quality. Such films are often laminated with oriented polypropylene films to obtain better stiffness, crispy feel and gloss for the overall package structure at the loss of oxygen permeability. Film structures identified in the last two examples of FIG. 17 represent such conventional laminated film structures. As shown in FIG. 17, these laminated films are limited to oxygen permeability of less than about 400 O₂ cc-mil/100 in²×day×atmosphere. Laminated films can only be sealed from one side and typically have curling issues. Producing laminated film adds extra processing steps in comparison to an extruded film, and also results in a more expensive product to produce. Such laminated films result in additional cost, reduced packaging speeds, decreased oxygen permeation rates or barrier properties, (which in turn leads to lost or contaminated product), and increased unacceptable packages due to inconsistent quality.

In contrast, packaging films made in accordance with the present technology can achieve different rates of O₂ and CO₂ permeation and improved barrier properties, and thereby achieve a wide range of CO₂/O₂ permeation ratios and reduced or prevented product contamination. For example, the different rates of O₂ and CO₂ permeation can be achieved by selecting a high permeability polymer or a blend of high permeability polymers, selecting a low permeability polymer or a blend of low permeability polymers, adjusting the relative amounts of high permeability polymer(s) and low permeability polymer(s) such that the high permeability polymer(s) comprise at least about 15 percent by weight of a blend of the high and low permeability polymers, and forming a film from the blend of high and low permeability polymers. Determining the selection of high permeability polymers and low permeability polymers and adjusting the relative amounts of each in order to achieve a targeted O₂ and/or CO₂ permeation rate can be accomplished by using a Maxwell model for droplet morphology.

FIG. 18 graphically illustrates the Maxwell model as it pertains to oxygen permeability of a blend of the present technology. This model can be used to provide an estimate to the final film oxygen permeability when a particular component in the blend either forms the major phase of the blend and the major phase volume comprises about 70% to about 100% of the blend, or the minor component forms droplets and the droplet volume comprises about 0% to about 30% of the blend. As can be seen from FIG. 18, the oxygen permeability of a blend composition increases essentially linearly as the major phase component increases from about 70% to about 100% of the blend volume, and decreases essentially linearly as the droplet volume decreases from about 30% to about 0% of the blend volume.

If, for example, a blend composition of the present technology has an oxygen permeability that ranges from a high of about 2000 O ₂ cc-mil/100 in²×day×atmosphere (when the major phase volume comprises 100% of the blend) to a low of about 850 O₂ cc-mil/100 in²×day×atmosphere (when the major phase volume comprises approximately 0% of the blend), illustrated by the square lines in FIG. 18, the oxygen permeability of a film made from the blend composition can be estimated when the major phase volume is either between about 100% to about 70% or about 30% to about 0%. From this example, it can be seen that if the major phase volume comprises about 70% of the blend, the oxygen permeability of the film will be about 1850, and if the major phase volume comprises about 10% of the blend (i.e., becomes the minor component in the blend) the oxygen permeability of the film will be about 900). Thus, if a particular oxygen permeability in the range of about 1850 to about 2000 or in the range of about 850 to about 1000 is desired for a film made from this particular blend described, one of ordinary skill in the art will appreciate the ability to adjust the amounts of the components in the blend in accordance with the FIG. 18 model to achieve the desired or targeted permeability.

Similar models can be established for any component blend of the present technology, as well as for gasses other than oxygen, by utilizing the following method: four films can be prepared—one film comprising 100% of one blend component, a second film comprising 100% of the other blend component, a third film comprising an 85:15 weight percent blend of the two components, and a fourth film comprising a 15:85 weight percent blend of the two components. The oxygen or other gas permeability can be measured for each of the four films using the methods described in connection with FIG. 4, and the permeability measurements can then be plotted as a function of major phase volume to achieve models similar to those illustrated in FIG. 18.

Where the models break down and make it difficult to predict the oxygen or other gas permeability of the blend occurs when the desired or targeted permeability is between about 30% and about 70% of the major phase volume. In this region, the blend is no longer dominated by droplet morphology and is more co-continuous in nature. The permeability of the blend in this region tends to be non-linear and therefore additional steps need to be taken to select and adjust the relative amounts of the components in the blend in order to achieve a selected permeability within this range.

To determine the major phase volume percentage to achieve a specific oxygen or other gas permeability when the targeted permeability is within the region of a co-continuous morphology, one can draw a line between the permeability of the blend at 70% major phase volume and the permeability of the blend at 30% major phase volume in a Maxwell model plot for the blend, then use the major phase volume that intersects with the targeted permeability at a point on the line as a starting point for the major phase volume for the blend. The oxygen or other gas permeability for a film made from the starting blend can then be measured to determine how close the film's permeability is to the targeted value. If the permeability is lower than the targeted value, additional amounts of high permeability polymer can be added to the blend in increments of about 5% to about 10% by weight until the permeability of the blend reaches or is close to the targeted value. Increments of about 1% to about 2% by weight high permeability polymer can be added to the blend to achieve the targeted permeability value if the permeability of the blend is close to the targeted value.

Similarly, if the oxygen or other permeability of the starting blend is higher than the targeted permeability value, additional amounts of low permeability polymer can be added to the blend in increments of about 5% to about 10% by weight until the permeability of the blend reaches or is close to the targeted value. Again, increments of about 1% to about 2% by weight low permeability polymer can be added to the blend to achieve that targeted value once the permeability of the blend is close to the targeted value.

The selection of the particular high permeability polymer or polymers and the particular low permeability polymer or polymers to be used in one or more blends of the present technology will depend, at least in part, on the properties of the particular polymers, including, without limitation, gas permeability, barrier property density, melt index, tensile properties, and clarity, as well as the end use for the film made from the polymers. The properties of the various polymers can be obtained from the manufacturers, and also from publicly available sources, such as, for example, Film Extrusion Manual (Thomas I. Butler, Editor, 2d ed. 2005), and www.diffusion-polymers.com, which lists the oxygen, carbon dioxide, nitrogen and hydrogen permeability values for different polymers.

In addition to the polymers selected for the films, the thickness or gauge of the film has an effect on the transmission rate of the film. Typically the transmissibility of the film increases as the film thickness is reduced, and likewise the transmissibility of the film is reduced as the film thickness increases. Accordingly, obtaining a targeted transmissibility value (e.g., gas transmission rate or barrier to particulates) can also be achieved by changing the gauge of the film, particularly when the permeability of the blend of polymers selected for the film is close to the targeted value. For example, the gauge of the film can be increased (or decreased) in increments of about 0.25 mil if the transmissibility is higher (or lower) than the targeted value in order to bring the transmissibility of the film in line with the targeted value.

In addition to achieving selected permeability and/or transmissibility rates, the films made in accordance with the present technology also have desirable optical, tensile and surface properties, that allow the films to be suitable for many flexible film applications, such as food and produce packaging.

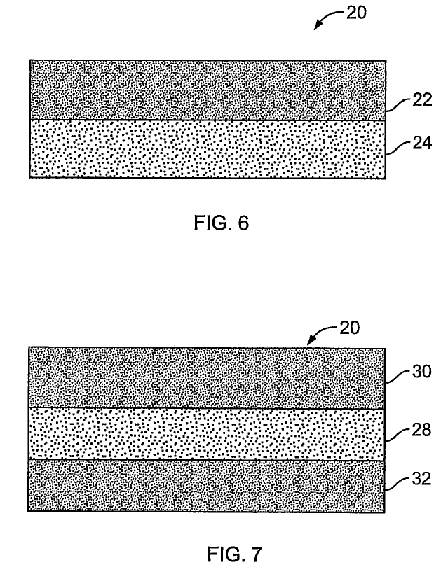

FIG. 6 illustrates a multilayer film according to at least one alternative embodiment of the present technology. The multilayer film, referenced generally at 20, comprises a selectively permeable layer 22 having a skin layer 24 disposed on one side of the selectively permeable layer. The multilayer film 20 has a total thickness in the range of about 0.5 to about 5 mil, alternatively in the range of about 1 to about 3 mil, preferably about 2 mil. The selectively permeable layer 22 is as described above in connection with FIGS. 1 and 2.

The skin layer 24 of this particular embodiment of the present technology provides desirable characteristics including, but not limited to, sealability stiffness and optical properties (e.g., gloss and clarity), and may comprise polymers and polymer blends. including, but not limited to, ethylene, olefin plastomer, polystyrene,. polypropylene, styrene-butadiene, combinations thereof, or derivatives thereof. The skin layer 24 may also include without limitation a perforated polymer film, a porous polymer film, a non-woven polymer fiber substrate, a woven polymer fiber substrate, a cellulose substrate (including paper and cardboard), or combinations thereof. The skin layer 24 may also include without limitation sealants, including, but not limited to, sealants having low-density polyethylene polymers.

The skin layer 24 may also include without limitation one or more resins, including, but n o t limited to, copolymers comprising ethylene-vinyl acetate, ethylene-acrylic acid, ethylene-methacrylic acid, derivatives thereof, or combinations thereof. These resin co-polymers include but are not limited to symmetric co-polymers, random co-polymers, graft co-polymers, block co-polymers, impact co-polymers, derivatives thereof, or combinations thereof. The resin may also include any ionomeric polymer.

The skin layer 24 may be co-extruded with the selectively permeable layer 22. Alternatively, the skin layer 24 may be laminated to the selectively permeable layer 22. In yet another alternative, the skin layer 24 may be extrusion coated to the selectively permeable layer 22 or the selectively permeable layer 22 may be extrusion coated onto other substrates. The co-extrusion, lamination, or extrusion coating whereby the skin layer 24 may be joined with the selectively permeable layer 22 contemplates conventional methods known to those skilled in the art.

The skin layer 24 of this embodiment of the present invention may preferably comprise polymers and polymer blends including, but not limited to, styrene butadiene copolymer, styrene butadiene rubber and polystyrene. Such skin layer may further comprise an ester based additive to provide anti-fog properties.

FIG. 7 illustrates another multilayer film of the present invention, referenced generally at 26 and having a core layer 28 comprising a selectively permeable polymer or polymer blend. The core layer 28 is further disposed between two skin layers 30 and 32. The core layer 28 is as described above in connection with FIGS. 1 and 2. The skin layers 30 and 32 are as described above in connection with FIG. 6. The multilayer film 26 also has a total thickness in the range of about 0.5 to about 5 mil, alternatively in the range of about 1 to about 3 mil, preferably about 2 mil.

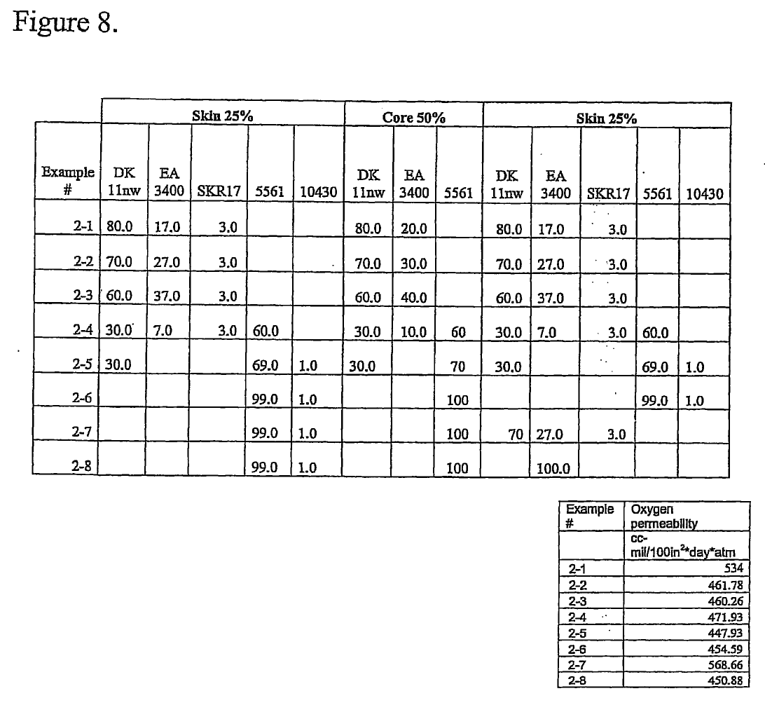

FIG. 8 presents film formulations of a multilayer film having only low permeability polymers in the core layer. Each multilayer film may be co-extrusion blown and comprises about 50 weight percent, based on the total weight of the multilayered film, of a core layer having only a low permeability polymer. The core layer is further disposed between two skin layers, each skin layer comprising about 25 weight percent of the total weight of the multilayered film.

The film formulations of FIG. 8 illustrate the limitations in achieving higher oxygen permeability when high oxygen permeability polymers and blends are not used. The core layer includes a polymer blend comprising different amounts and combinations of a styrene-butadiene copolymer (for example, DK 11nw sold by The Chevron Phillips Chemical Company LP of The Woodlands, Tex.), a polystyrene (for example, EA 3400 sold by The Chevron Phillips Chemical Company LP of The Woodlands, Tex.), and low density polyethylene (for example, 5561 sold by The Chevron Phillips Chemical Company LP of The Woodlands, Tex.). All of these polymers are low permeability polymers.

Each skin layer comprises a polymer blend that may include without limitation different amounts and combinations of a styrene-butadiene copolymer (for example, DK 11nw and/or DK 13 sold by The Chevron Phillips Chemical Company LP of The Woodlands, Tex.), a polystyrene (for example, EA 3400 sold by The Chevron Phillips Chemical Company LP of The Woodlands, Tex.), a slip and anti-block masterbatch (for example, SKR17 sold by The Chevron Phillips Chemical Company LP of The Woodlands, Tex.), low density polyethylene (for example, 5561 sold by The Chevron Phillips Chemical Company LP of The Woodlands, Tex.), and slip anti-block polyethylene masterbatch (for example, 10430 sold by Ampacet of Tarrytown, N.Y.).

As shown in FIG. 8, the oxygen permeability of these films that do not include high permeability polymers in their core layer posses lower oxygen permeability—i.e., below about 600 O₂ cc-mil/100 in²×day×atmosphere, specifically from about 450 to about 570 O₂ cc-mil/100 in²×day×atmosphere.

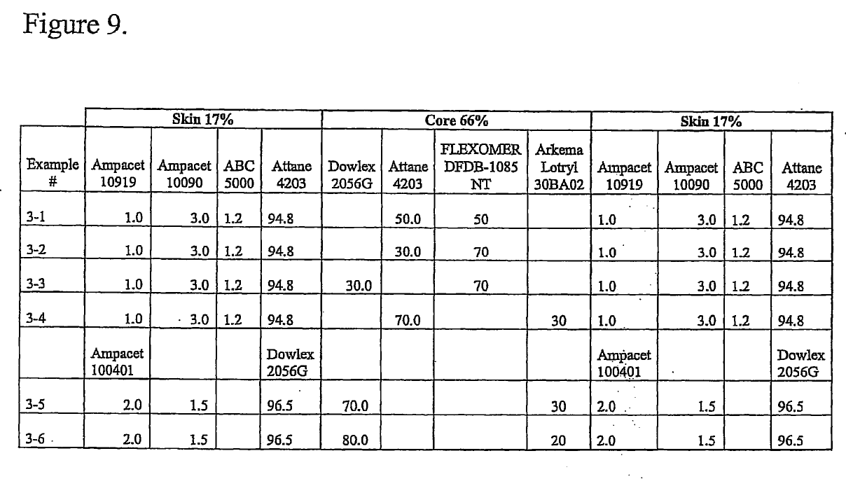

FIG. 9 presents exemplar formulations of the multilayer film illustrated in FIG. 7. Each multilayer film is co-extrusion blown and comprises about 66 weight percent, based on the total weight of the multilayered film, of a core layer having a selectively permeable polymer or polymer blend. The core layer is further disposed between two skin layers, each skin layer comprising about 17 weight percent based on the total weight of the multilayered film.

The core layer includes without limitation a selectively permeable polymer blend comprising different amounts and combinations of a polyethylene polymer (for example, Dowlex 2056G sold by the Dow Chemical Company), an ultra low density ethylene/octene copolymer (for example, Attane 4203 sold by the Dow Chemical Company), a very low density polyethylene (for example, FLEXOMER DFDB 1085 NT sold by Dow Chemical Company), and ethylene-butyl acrylate (for example, Lotryl 30BA02 sold by Arkema of Puteaux, France). The core layer alone of the exemplar formulations of FIG. 9 may be used as an end-use film to provide desirable selective gas permeation characteristics.

The low permeability polymers of the core layer of the films of FIG. 9 are Dowlex 2056G. The remaining polymers identified in the core layer of the films of FIG. 9 are high permeability polymers.

Each skin layer comprises a polymer blend that includes without limitation different amounts and combinations of polyethylene process aid (masterbatch) (for example, Ampacet 10919 sold by Ampacet of Tarrytown, N.Y.), polyethylene slip masterbatch (for example, Ampacet 10090 sold by Ampacet of Tarrytown, N.Y.), polyethylene antiblock masterbatch (for example, ABC 5000 sold by Polyfil Corporation of Rockaway, N.J.), an ultra low density ethylene/octene copolymer (for example, Attane 4203 sold by the Dow Chemical Company), polyethylene antioxidant masterbatch (for example, Ampacet 100401 sold by Ampacet of Tarrytown, N.Y.), and a polyethylene polymer (for example, Dowlex 2056G sold by the Dow Chemical Company). The core layer may also comprise similar process aids.

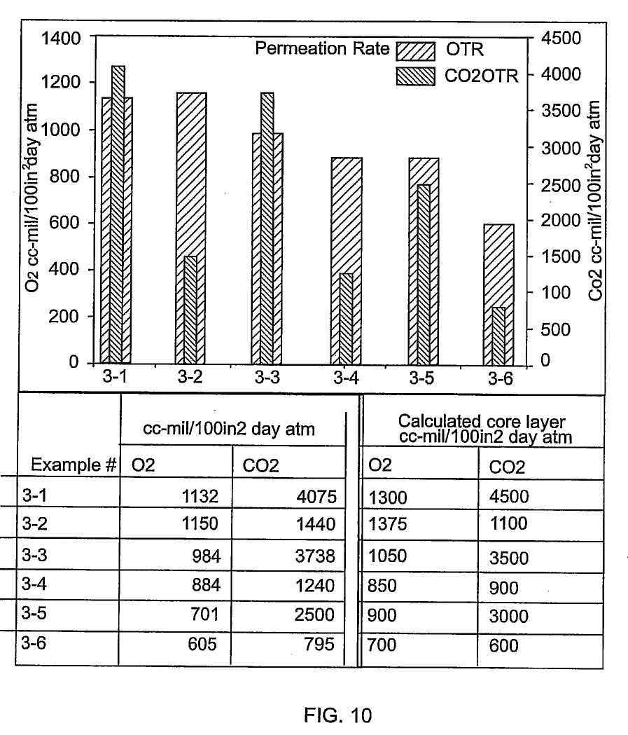

FIG. 10 presents O₂ and CO₂ permeation rates for the multilayer films presented in FIG. 9. The O₂ and CO₂ permeation rates were tested using MOCON equipment, as above. The permeation rates were calculated from the transmission rate and the sample thickness. O₂ permeation rate was determined by using 100 cm² and CO₂ permeation rate was determined using a 5 cm² film sample. Both O₂ and CO₂ permeation rates were determined at a temperature of 23.0° C., a permeant gas concentration of 100 percent, and a permeant relative humidity of about 50 percent. Oxygen permeation rates for individual films ranged from about 600 O₂ cc-mil/100 in²×day×atmosphere to about 1150 cc-mil/100 in²×day×atmosphere. These oxygen permeation rates are significantly higher than those of the FIG. 8 film formulations which utilized only low permeability polymers. By adjusting the polymers of the core layer for the film formulations of FIG. 9, it is expected that the O₂ permeation rate may be increased to at least about 2000 O₂ cc-mil/100 in²×day×atmosphere at about 23° C. For example, by utilizing FLEXOMER DFDB 1085, which has a very high oxygen transmission rate, as the high permeability polymer in the core layer, and utilizing such polymer in amounts of about 70% by weight or greater, it is expected that films having an O₂ permeation rate of about 2000 O₂ cc-mil/100 in²×day×atmosphere can be achieved. Carbon dioxide permeation rates for individual films ranged from about 775 CO₂ cc-mil/100 in²×day×atmosphere to about 4100 cc-mil/100 in²×day×atmosphere. The CO₂/O₂ permeation rate ratio for individual films ranged from about 1.3 to about 4.

The calculation of permeation across a subject core layer can be done by examining transfer through the entire structure and using known permeation rate values for the skin layers. Using this calculation, the permeation rates for the core layers of the examples of FIG. 9 have been calculated and range from about 900 to about 1600 for O₂ and from about 900 to about 6000 for CO₂, as reflected in FIG. 10. The CO₂/O₂ permeation rate ratio for individual films ranged from about 0.85 to about 4.

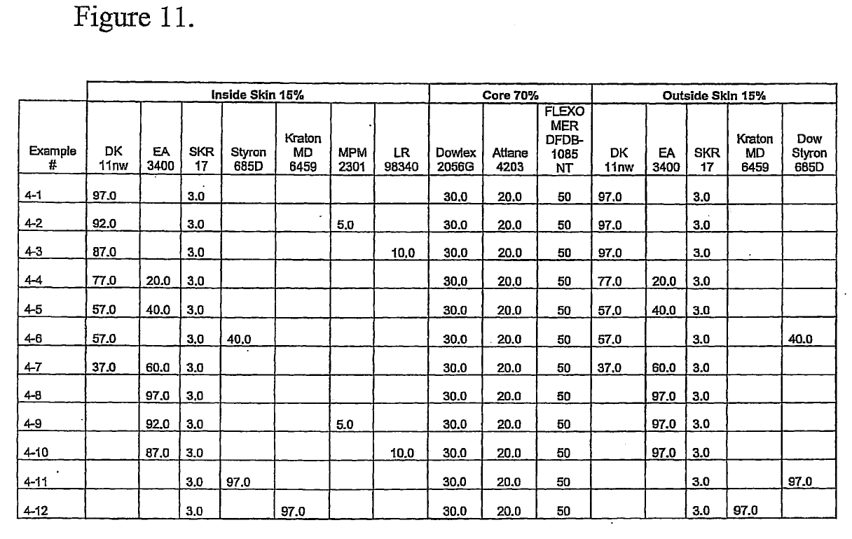

FIG. 11 presents yet further exemplar formulations of the multilayer films illustrated in FIG. 7. Each multilayer film is co-extrusion blown and comprises about 70 weight percent, based on the total weight of the multilayered film, of a core layer having a selectively permeable polymer or polymer blend. The core layer is further disposed between an inside skin layer and an outside skin layer, each skin layer individually comprising about 15 weight percent of the total weight of the multilayered film. Each skin layer can further be optimized for but not limited to sealability, stiffness, gloss and coefficient of friction.

The core layer includes without limitation a selectively permeable polymer blend comprising about 30 weight percent of a polyethylene polymer (Dow 2056G), about 20 weight percent of an ultra low density ethylene/octene copolymer (for example, Attane 4203 sold by the Dow Chemical Company), and about 50 weight percent a very low density polyethylene (for example, FLEXOMER DFDB 1085 NT sold by Dow Chemical Company). The low permeability polymers of the core layer of the films of FIG. 11 are Dowlex 2056G. The remaining polymers identified in the core layer of the films of FIG. 11 are high permeability polymers.

The inside skin layers comprise polymer blends having different amounts and combinations of a styrene-butadiene copolymer (for example, DK 11nw sold by Chevron Phillips), a polystyrene polymer (for example, EA 3400 sold by Chevron Phillips), a styrene-butadiene copolymer (for example, SKR17 sold by The Chevron Phillips Chemical Company LP of The Woodlands, Tex.), a polystyrene resin (for example, Dow Styron 685D sold by Dow Chemical), styrene butadiene styrene polymer (for example, Kraton MD 6459 sold by Kraton Polymers of Houston, Tex.), an anti-fog (masterbatch) (for example, MPM 2301 developmental grade by Mayzo Corp, Atlanta, Ga. or LR 98340 developmental grade by Ampacet).

The outside skin layers comprise different polymer blends having different amounts and combinations of a styrene-butadiene copolymer (for example, DK 11nw and DK 13 sold by Chevron Phillips), a polystyrene polymer (for example, EA 3400 sold by Chevron Phillips and/or Dow Styron 685D sold by Dow Chemical), a slip antiblock masterbatch (for example, SKR17 sold by The Chevron Phillips Chemical Company LP of The Woodlands, Tex.), styrene butadiene styrene polymer (for example, Kraton MD 6459 sold by Kraton Polymers of Houston, Tex.).

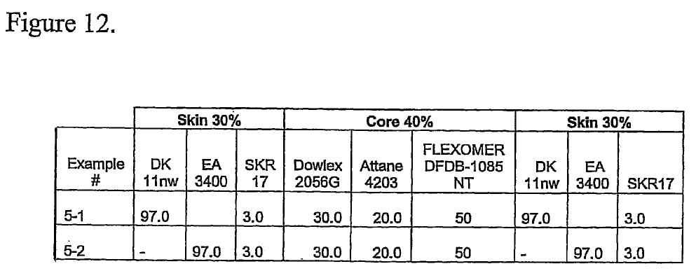

FIG. 12 presents still other exemplar formulations of the multilayer films illustrated in FIG. 7. Each multilayer film is co-extrusion blown and comprises about 40 weight percent, based on the total weight of the multilayered film, of a core layer having a selectively permeable polymer or polymer blend. The core layer is further disposed between two skin layers, each skin layer comprising about 30 weight percent of the total weight of the multilayered film.

The core layer comprises, based on the total weight of the core layer, a selectively permeable polymer blend having about 30 weight percent of a polyethylene polymer (Dow 2056G), about 20 weight percent of an ultra low density ethylene/octene copolymer (for example, Attane 4203 sold by the Dow Chemical Company), and about 50 weight percent of a very low density polyethylene (for example, FLEXOMER DFDB 1085 NT sold by Dow Chemical Company). The low permeability polymers of the core layer of the films of FIG. 12 are Dowlex 2056G. The remaining polymers identified in the core layer of the films of FIG. 12 are high permeability polymers.

Both skin layers comprise a polymer blend that includes without limitation different amounts and combinations of styrene-butadiene copolymer (for example, DK 11nw sold by Chevron Phillips), a polystyrene polymer (for example, EA 3400 sold by Chevron Phillips), and a styrene-butadiene copolymer (for example, SKR17 sold by The Chevron Phillips Chemical Company LP of The Woodlands, Tex.).

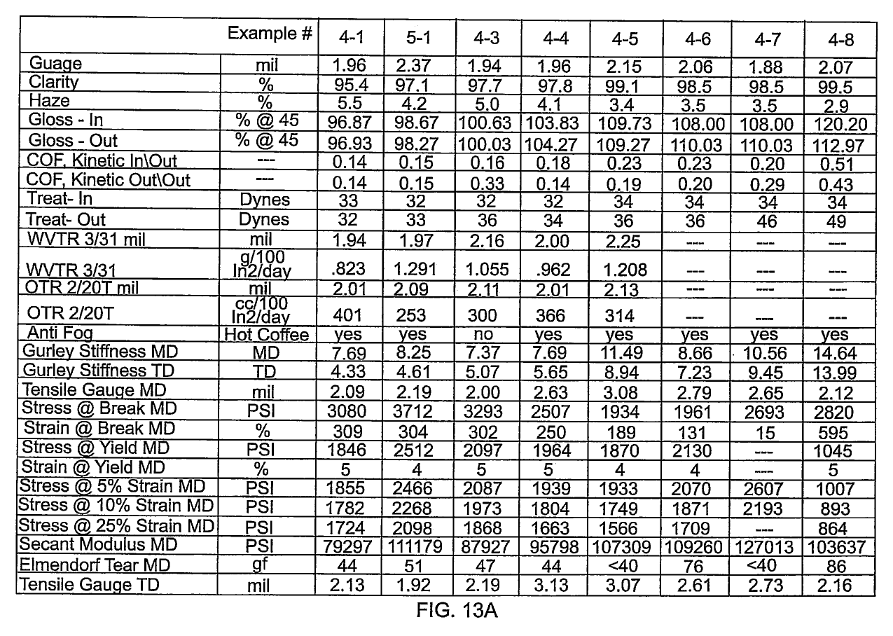

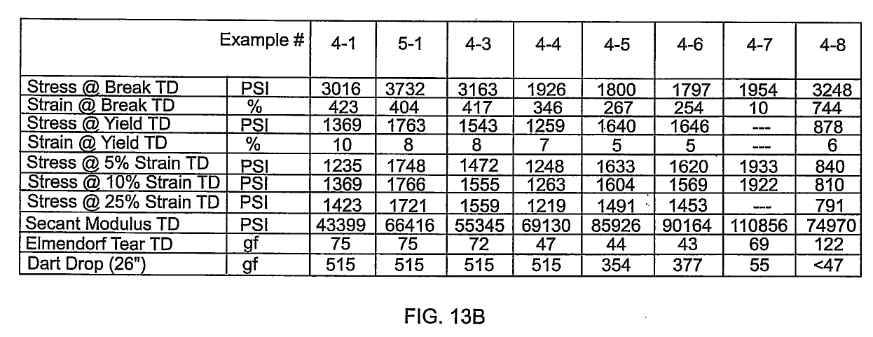

FIG. 13 presents optical, surface, and tensile properties for selected films presented in FIGS. 11 and 12. Optical properties presented include clarity, haze, gloss-in, and gloss-out numbers. As demonstrated in FIG. 13, the films made from the selectively permeable blends in combination with skin layers provide excellent optical characteristics indicated by high gloss, low haze and high clarity in combination with excellent strength characteristics indicated by high secant modulus and stress at break. These films do not experience curling which is a common problem in laminated film structures. These films may also be heat sealable from both sides.

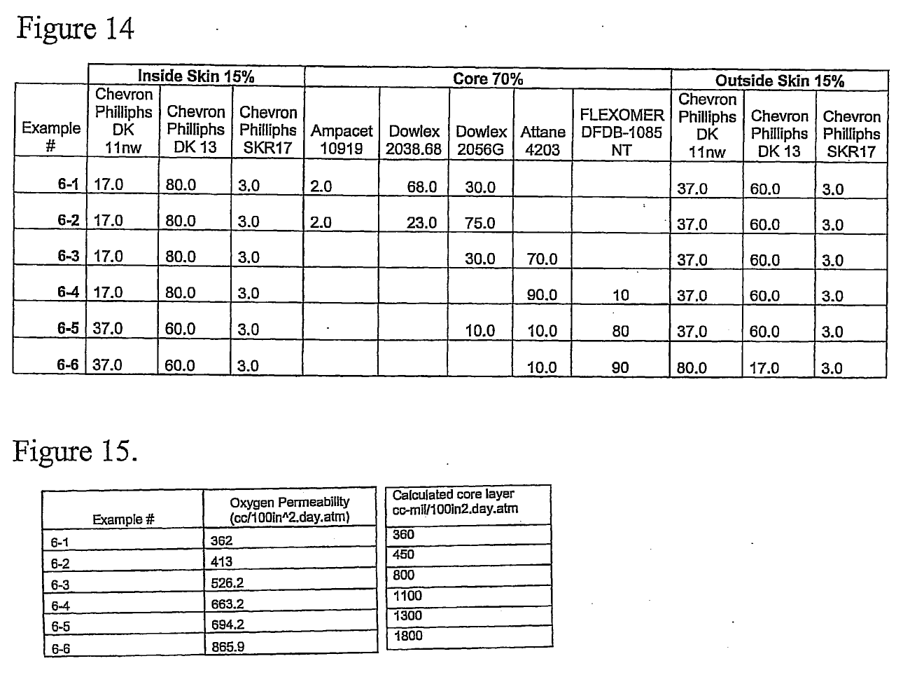

FIG. 14 presents still other exemplar formulations of the multilayer film illustrated in FIG. 7, and comprise a core layer disposed between an inside skin layer and an outside skin layer. The core layer comprises about 70 weight percent of the multilayer film, and includes without limitation a polyethylene process aid masterbatch (for example, Ampacet 10919 sold by Ampacet), a selectively permeable polymer blend comprising different amounts of a linear low density polyethylene (for example, Dowlex 2038.68 sold by the Dow Chemical Company), a polyethylene polymer (for example, Dowlex 2056G sold by the Dow Chemical Company), an ultra low density ethylene/octene copolymer (for example, Attane 4203 sold by the Dow Chemical Company), and a very low density polyethylene (for example, FLEXOMER DFDB 1085 NT sold by Dow Chemical Company).

The low permeability polymers of the core layer of the films of FIG. 14 are Dowlex 2056G and Dowlex 2038.68. The remaining polymers identified in the core layer of the films of FIG. 14 are high permeability polymers.

The inside and outside skin layers each individually comprise about 15 weight percent of the multilayer film, and each comprises a polymer blend that includes without limitation different amounts and combinations of a styrene-butadiene copolymer (for example, DK 11nw sold by Chevron Phillips), a second styrene-butadiene copolymer (for example, DK 13 sold by Chevron Phillips), and a slip antiblock masterbatch (for example, SKR17 sold by The Chevron Phillips Chemical Company LP of The Woodlands, Tex.).

FIG. 15 presents O₂ permeation rates for the multilayer films presented in FIG. 14. The O₂ permeation rates were determined using MOCON equipment (as described above) and a 100-cm²-film sample, at a temperature of 23.0° C., a gas concentration of 100 percent, and a permeant relative humidity of about 50 percent. Oxygen permeation rates for the individual films tested ranged from about 350 O₂ cc-mil/100 in²×day×atmosphere to about 875 cc-mil/100 in²×day×atmosphere. By adjusting the formulations of the core layer this range may be easily expanded to an oxygen permeation rate of from about 250 to about 900 O₂ cc-mil/100 in²×day×atmosphere at about 23° C. Such adjustments include increasing the amount of low permeability polymer in the core layer formulation and/or utilizing a low permeability polymer with a very low oxygen transmission rate to decrease the oxygen permeation rate, or, in order to increase the oxygen permeation rate, increasing the amount of high permeability polymer in the core layer formulation, and/or utilizing as the high permeability polymer a polymer having a very high oxygen transmission rate, such as FLEXOMER DFDB 1085 sold by Dow Chemical Company.

The core layer alone of the exemplar formulations of FIG. 14 may be used as an end-use film to provide desirable selective gas permeation characteristics. The permeation rates of the core layer alone as a film may be calculated as noted above and are reflected in FIG. 15. The permeation rates for the core layer alone for the films of FIG. 14 range from about 350 to about 1800 for O₂. The core layers with the lowest O₂ permeation rates (see examples 6-1, 6-2) are core layers made of only low permeability polymer blends and result in core layer permeation rates of about 360 and about 450 O₂ cc-mil/100 in²×day×atmosphere. The core layers with high permeability polymers (examples 6-3 to 6-6) demonstrate higher O₂ permeation rates ranging from about 800 to about 1800 O₂ cc-mil/100 in²×day×atmosphere.

The O₂ permeation rates of the core layer may be adjusted from about 600 to about 2500 O₂ cc-mil/100 in²×day×atmosphere at about 23° C. For example, example 3-6 of FIGS. 9 and 10 demonstrate a calculated core layer O₂ permeation rate of 700 cc-mil/100 in²×day×atmosphere. By increasing the amount of low permeability polymer in the core formulation, an O₂ permeation rate of 600 cc-mil/100 in²×day×atmosphere can be achieved. Modifications may also be made to increase the oxygen permeability rate. For example, by utilizing as the high permeability polymer a polymer having a very high oxygen transmission rate, such as, for example FLEXOMER DFDB 1085 sold by Dow Chemical Company, and adding such a polymer in an amount of about 70% by weight or greater, the core formulation may be made to achieve an O₂ permeation rate of about 2500 cc-mil/100 in²×day×atmosphere.

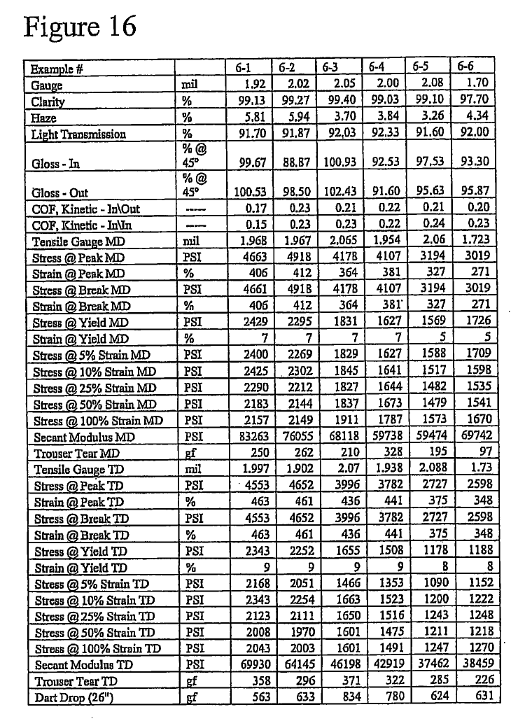

FIG. 16 presents optical, surface, and tensile properties for the films presented in FIG. 14. Optical properties presented include clarity, haze, gloss-in, and gloss-out numbers. As demonstrated in FIG. 16, the films made from the selectively permeable blends in combination with skin layers in accordance with the present technology provide excellent optical characteristics indicated by high gloss, low haze and high clarity in combination with excellent strength characteristics indicated by high secant modulus and stress at break. These films. do not have curling which is a common problem in laminated film structures. These films may also be heat sealable from both sides.

The films according to the present technology can further have at least one additive. Additives include, but are not limited to, calcium carbonate, silica particles, zeolites, metallic particles, colorants, antifog agents, antistatic agents, ultra violet light inhibitors, ultra violet stabilizers, volatile corrosion inhibitors, friction reduction agents, slip agents, antiblock, odorants, deodorants, odor-scavenging agents, antioxidants, oxygen scavengers, freshness indicators, processing aids, thermal stabilizing agents, anti-microbial agents, dry film preservatives, flavor agents, aroma agents, chlorine dioxide releasing agents, sulphur dioxide release agents, ethylene scavengers, derivatives thereof and combination thereof.

There are a number of uses for the films of the present technology, including but not limited to packaging films. In particular, the films of the present technology are useful as foodstuffs packaging, especially where improved selective permeability and barrier properties are desired. Foodstuffs can include any substance with food value, including without limitation the raw material of food before or after processing. Exemplar foodstuffs include but are not limited to any fresh-produce, meat, dairy, or combinations thereof.

The films of the present technology may also be used as separation membranes having different permeation rates for different gases, liquids, particulate matter, and combinations thereof. As noted herein, it should be understood by those skilled in the art that the films of the present technology exhibit improved barrier properties to particulate matter such as dust, dirt, and/or microbes. In doing so, the present technology reduces or prevents contamination and subsequent loss of materials (e.g., perishable foods) that can be packaged with or in such films. As a result, a cost savings occurs due to such contamination and/or loss reduction or prevention.

The invention has now been described in such full, clear, concise and exact terms as to enable any person skilled in the art to which it pertains to practice the same. It is to be understood that the foregoing describes preferred embodiments and examples of the invention and that modifications may be made therein without departing from the spirit or scope of the invention as set forth in the claims.

What is claimed is:

1. An extruded film comprising a film composition of a high permeability polymer component and a low permeability polymer component, the high permeability polymer component comprising from about 15% to about 100% by weight of the film composition and the low permeability polymer component comprising up to about 85% by weight of the film composition, wherein the film is a monolithic film having a CO/O₂ permeation ratio of from about 0.85 to about 11.

2. The film of claim 1, wherein the high permeability polymer component comprises: ethylene-vinyl acetate, ethylene-butyl acrylate, ethylene-methyl acrylate, urethane, polyethylene, poly propylene, propylene-ethylene copolymer, polyolefin, styrene butadiene, polystyrene, derivatives thereof, or combinations thereof.

3. The film of claim 1, wherein the high permeability polymer component is an ionomeric polymer.

4. The film of claim 1, wherein the high permeability polymer component is thermoplastic.

5. The film of claim 1, wherein the high permeability polymer component is a plastomer.

6. The film of claim 1, wherein the high permeability polymer component is a rubber.

7. The film of claim 1, wherein the high permeability polymer component comprises a low-density polyethylene, a very-low-density polyethylene, an ultra-low-density polyethylene, a linear-low-density polyethylene, derivatives thereof, or combinations thereof.

8. The film of claim 1, wherein the high permeability polymer component comprises a symmetric co-polymer, a random co-polymer, a graft co-polymer, a block co-polymer, an impact co-polymer, or combinations thereof.

9. The film of claim I, wherein the low permeability polymer component comprises polyethylene, polypropylene, propylene-ethylene copolymer, ethylene vinyl acetate copolymer, polyolefin, styrene butadiene, polystyrene, derivatives thereof, or combinations thereof.

10. The film of claim 1, wherein the low permeability polymer component is thermoplastic.

11. The film of claim I, wherein the low permeability polymer component is a plastomer.

12. The film of claim 1, wherein the low permeability polymer component is a rubber.

13. The film of claim 9, wherein the low permeability polymer component comprises: a low-density polyethylene, a linear-low-density polyethylene, derivatives thereof, or combinations thereof.

14. The film of claim 1, wherein the low permeability component comprises: a symmetric co-polymer, a random co-polymer, a graft co-polymer, a block co-polymer, an impact co-polymer, or combinations thereof.

15. The film of claim 1, further comprising at least one additional layer.

16. The film of claim 15, wherein the additional layer comprises a polymer, copolymer, or blend thereof.

17. The film of claim 16, wherein the polymer, copolymer, or blend thereof of the additional layer comprises polystyrene, styrene-butadiene, styrene co-polymers, derivatives thereof, or combinations thereof.

18. The film of claim 15, wherein the additional layer comprises a perforated polymer film, a porous polymer film, a non-woven polymer fiber substrate, a woven polymer fiber substrate, a cellulose substrate, a resin, or combinations thereof.

19. The film of claim 18, wherein the resin is a copolymer comprising ethylene-vinyl acetate, ethylene-acrylic acid, ethylene-methacrylic acid, polyethylene, polypropylene, derivatives thereof, or combinations thereof.

20. The film of claim 19, wherein the copolymer comprises a symmetric co-polymer, a random co-polymer, a graft co-polymer, a block co-polymer, an impact co-polymer, combinations thereof.

21. The film of claim 18, wherein the resin comprises an ionomeric polymer.

22. A packaging film comprising an extrusion product that is formed from a blend of a high permeability polymer component and a low permeability polymer component; the high permeability polymer component comprising from about 15% to about 100% by weight of the blend and the low permeability polymer component comprising up to about 85% by weight of the blend, wherein the extrusion product is a monolithic film having a CO₂/O₂ permeation ratio of from about 0.85 to about 11.

23. A foodstuffs packaging film comprising an extrusion product formed from a blend of a high permeability polymer component and a low permeability polymer component; the high permeability polymer component comprising from about 15% to about 100% by weight of the blend and the low permeability polymer component comprising up to about 85% by weight of the blend, wherein the extrusion product is a monolithic film having a CO₂/O₂ permeation ratio of from about 0.85 to about 11.

24. The film of claim 23, wherein the foodstuffs comprise meat, dairy, produce, or combinations thereof.

25. A selectively permeable film comprising an extrusion product formed from a blend of a high permeability polymer component and a low permeability polymer component; the high permeability polymer component comprising from about 15% to about 100% by weight of the blend and the low permeability polymer component comprising up to about 85% by weight of the blend, wherein the extrusion product is a monolithic film having a CO₂/O₂ permeation ratio of from about 0.85 to about 11.

26. The film of claim 25, wherein the film has a reduced permeability to at least one microbial agent.

27. The film of claim 25, wherein the film has a reduced permeability to at least one solid.

28. The film of claim 26, wherein the at least one microbial agent comprises a virus, a bacteria, a fungus, or a protozoa.

29. The film of claim 25, wherein the film has a carbon dioxide permeation rate of from about 580 to about 6200 CO₂ cc-mil/100 in²×day×atmosphere at about 23° C.

30. The film of claim 25, wherein the film has an oxygen permeation rate of from about 600 to about 2500 O₂ cc-mil/100 in²×day×atmosphere at about 23° C.

31. The film of claim 25, further comprising at least one additional layer, the additional layer comprising ethylene-vinyl acetate, ethylene-acrylic acid, ethylene-methacrylic acid, polyethylene, polypropylene, derivatives thereof, or combinations thereof.

32. The film of claim 31 having an oxygen permeation rate of from about 600 to about 2000 O₂ cc-mil/100 in²×day×atmosphere at about 23° C.

33. The film of claim 25, further comprising at least one additional layer, the additional layer comprising polystyrene, styrene-butadiene, styrene co-polymers, derivatives thereof, or combinations thereof.

34. The film of claim 33 having an oxygen permeation rate of from about 250 to about 900 O₂ cc-mil/100 in²×day×atmosphere at about 23° C.

35. The film of claim 25, wherein the film further comprises at least one additive.

36. The film of claim 35, wherein the additive comprises calcium carbonate, silica particles, zeolites, metallic particles, a colorant, an antifog agent, an antistatic agent, an ultra violet light inhibitor, an ultra violet stabilizer, a volatile corrosion inhibitor, a friction reduction agent, a slip agent, an antiblock, an odorant, a deodorant, an odor-scavenging agent, an antioxidant, an oxygen scavenger, a freshness indicator, a processing aid, a thermal stabilizing agent, an antimicrobial agent, a dry film preservative, a flavor agent, an aroma agent, or combinations thereof.

37. The film of claim 25, wherein the blend is a monoblend of the high permeability polymer component.

38. A method of making a selectively permeable film comprising the steps of:
a. selecting at least one high permeability polymer component;
b. selecting at least one low permeability polymer component;
c. blending the high permeability polymer component and the low permeability polymer component together to form a blend;
d. adjusting the amounts of high permeability polymer component and low permeability polymer component in the blend until a selected permeability value is achieved; and
e. forming a film from the blend of the high permeability polymer component and the low permeability polymer component.

39. The method of claim 38, wherein the film is made in a single converting step.
